(19) United States
(12) Patent Application Publication
(10) Pub. No.: US 2016/0332045 A1
(43) Pub. Date: Nov. 17, 2016

(54) DEVICE FOR REPAIRING UNEVEN AREAS IN A GREEN SPACE DISPOSED ON A GROUND AND GOLF CLUB HAVING SUCH A DEVICE

(71) Applicant: HOFMANN & LUMPI OG, Aurach (AT)

(72) Inventors: Werner Hofmann, Velden (AT); Hansjörg Lumpi, Aurach (AT)

(21) Appl. No.: 15/111,598

(22) PCT Filed: Jan. 16, 2015
(86) PCT No.: PCT/EP2015/050796

§ 371 Date: Jul. 14, 2016

(30) Foreign Application Priority Data
Jan. 17, 2014 (AT) A50029/2014

(51) Int. Cl. A63B 57/50; A01B 1/24

(52) U.S. Cl. CPC A63B 57/50; A01B 1/24

(57) ABSTRACT

The invention relates to a device (10) for repairing uneven areas in a green space disposed on a ground, being suitable for being attached to a grip (110) of a golf club (100). The device (10) comprises an attaching element (30; 90) by means of which the device (10) can be attached to the grip (110); an insertion element (20) suitable for being inserted in the ground for repairing the uneven areas; a covering element (50) for covering the insertion element (20), and a connecting element (40) releasably connected to the covering element (50) by means of a bayonet joint. The connecting element (40) comprises at least one recess (70) having a starting segment (71) and an end segment (72) for forming the bayonet joint. The covering element (50) comprises at least one protrusion (60) engaging in the recess (70) and being displaceable from the starting segment (71) to the end segment (72).

The invention relates to a device for repairing uneven areas in a green space disposed on a ground. The device is suitable for being attached to a grip of a golf club.

The device is particularly a so-called pitchfork or divot tool, an Implement used in the sport of golf to repair holes or dents, known as pitchmarks, that arise from balls falling from a relatively great height and Impacting on the so-called “green” of a golf course, a green space disposed on a ground. The origin of said pitchmarks is that, in golf, balls hit toward the hole from a short distance often are hit in a high arc, known as a pitch, in order to prevent the ball from rolling too far on the short-trimmed grass of the “green.” If the pitchmarks are not repaired, then the area around the hole becomes uneven, making it more difficult to sink a ball in the hole, known as putting, in later rounds. In order to repair pitchmarks or uneven areas, a typically two-pronged fork is inserted into the grass at a slight angle around the dent and the head of the pitchfork is pressed toward the dent so that the sod is broken. This is repeated until a mushroom-like bulge is formed at the spot where the dent was. The ground around the pitchmark is loosened in this manner and can then be flattened again using the putter, so that barely any visible trace remains.

Pitchforks exist in a wide range of embodiments. Typically they are carried by the golfer as a separate utensil during the game, for example in a trouser pocket.

It is, however, also known that the pitchfork is attached to the end of the grip of a golf club in order to be able to use the golf club as a handle for the pitchfork. For example, such a pitchfork is disclosed in US 2006/0025230 A1 and U.S. Pat. No. 5,423,543.

A pitchfork attached to the grip end of a golf club, disposed displaceably along a longitudinal axis, in order to be brought from a usage position in which the prongs of the pitchfork protrude from the grip end into a storage position in which the prongs of the pitchfork are placed inside the grip is described by U.S. Pat. No. 5,511,785. Such pitchforks displaceable between a usage position and a storage position also arise from U.S. Pat. No. 4,955,609, US 2003/0109336 A1 and U.S. Pat. No. 7,351,158 B1.

In addition, U.S. Pat. No. 4,925,190 and U.S. Pat. No. 5,277,425 disclose pitchforks attached at the end of the grip of a golf club, that are protected when not in use by a separate covering cap. The covering cap is placed on the pitchfork with a force fit.

A repair tool attached to the end of the grip of a golf club and covered by a covering cap placed by means of a force fit when not in use is further disclosed in US 2007/0060412 A1. The repair tool is attached to the grip end by means of a screw.

A pitchfork having a screw thread that can be screwed into the grip end of a golf club is disclosed by US 2007/0298900 A1. The pitchfork comprises a middle segment having an external thread. The external thread makes it possible to thread on a covering cap for covering the pitchfork when not in use.

The aim of the invention is to produce a device for repairing uneven areas in a green space present on a ground, particularly the green of a golf course, which can be attached to the grip of a golf club and by which the handling of the golf club is not impaired.

Said object is achieved by a device according to claim 1 or claim 2 and a golf club according to claim 17. Advantageous embodiments of the device and the golf club are the objects of claims 3 through 16 and 18 through 20.

The device according to the invention for repairing uneven areas in a green space disposed on a ground comprises an attaching element by means of which the device can be attached to the grip of a golf club and an insertion element suitable for inserting in the ground in order to repair uneven areas. The insertion element is particularly a pitchfork. The device further comprises a covering element or cap for covering the insertion element. The user of the golf club is protected by the covering element against injuries that could be caused by the insertion element.

The device further comprises a connecting element that can be releasably connected to the covering element by means of a bayonet joint. The connection between the covering element and the connecting element is thereby made by means of a push and turn motion. The connecting element comprises at least one recess having a starting segment and an end segment for forming the bayonet joint. The covering element comprises at least one protrusion engaging in the recess that can be displaced form the starting segment into the end segment for connecting the covering element and the connecting element. In order to release the covering element from the connecting element, the protrusion is displaced from the end segment back into the starting segment. At least one recess can be formed alternatively or additionally on the covering element and at least one protrusion engaging in the recess can be formed on the connecting element.

If the protrusion is present in the starting segment then the covering element can be separated from the connecting element and the covering element can thereby be removed from the insertion element. The protrusion is held in the recess in the end segment, in contrast, by means of form and force fits. The covering element is reliably connected to the connecting element in this manner, so securely that the handling of the golf club is not impaired. The covering element is not accidentally released when using the golf club, nor is the so-called grip pressure that is important for holding the golf club influenced by the covering element.

In a preferred embodiment of the device according to the invention, the connecting element comprises a top side, a bottom side, and a shell surface that is preferably cylindrical, particularly circular cylindrical. The connecting element preferably comprises a top part and a bottom part having a smaller diameter than the top part. The recess is preferably implemented as a groove extending along the shell and following a trajectory. The trajectory or a further trajectory can alternatively or additionally extend along a preferably cylindrical, particularly circular cylindrical, interior surface of the covering element, particularly whenever the protrusion is alternatively or additional implemented on the connecting element.

It is particularly advantageous if the trajectory has at least one local minimum in the transition region from the starting segment to the end segment. The sign of the slope of the trajectory in the starting segment is preferably opposite the sign of the slope in the end segment, at least in the region of the minimum. The protrusion is advantageously displaceable from the starting segment to the end segment, opposing the action of a return force acting in an axial direction. If the protrusion is displace in the starting segment along a falling trajectory, then the sign of the slope of the trajectory is negative, for example. After reaching the minimum, the sign of the slope of the trajectory changes and is positive. The protrusion is accordingly displaced in the end segment along a rising trajectory. Particularly if the displacement of the protrusion to the minimum occurs against the action of an axial return force, such as a spring force, then the rising trajectory prevents the protrusion from returning on its own. If the covering element is accordingly rotated far enough to pass the minimum, then the covering element and the connecting element are in tension relative to each other.

The end segment is advantageously limited by an end stop for the protrusion. The slope of the trajectory preferably decreases in the end segment toward the end stop. A local maximum is preferably present just before the end stop, that is, the trajectory falls again slightly toward the end stop. Particularly if the displacement of the trajectory to the minimum occurs against the action of an axial return force, the force with which the covering element and the connecting element are in tension with each other when the end stop is reached can be specifically defined by means of the slope of the trajectory, in order to ensure secure seating as well as easy releasing of the covering element. The user also receives feedback due to the end stop when the covering element is securely connected to the connecting element.

In a preferred embodiment of the device according to the invention, the covering element comprises a top side and a bottom side and comprises at least one cavity opening on the bottom side. The cavity is preferably suitable for receiving the insertion element and the connecting element. Further cavities can, for example, serve for providing the covering element with a particular deformability or hardness. Harder grips provide good control and often encourage the payer to hold the club with less pressure in the hand. Softer grips, in contrast, are generally more comfortable to hold.

It is particularly advantageous if the covering element is made of an elastically deformable material at least in areas, particularly in the area of the protrusion or the recess. A suitable material, for example, is rubber. The material rubber is easy to form and to produce and provides a solid, adhesive feeling. Other suitable materials could be, for example, silicone, elastomers, or other elastically deformable plastic or mixtures of the above materials.

In a preferred embodiment of the device according to the invention, the covering element comprises a contact surface on the bottom side that is suitable for making contact with the end surface of the grip or a part of the grip of a golf club. If, for example, an existing golf club is retrofitted with the device according to the invention, it is possible to cut off part of the grip and to replace the same with a covering element having corresponding haptics and grip strength to the cut off portion. In this case the cut surface forms the end surface.

The contact surface preferably comprises locations having a friction-reducing surface, at least in segments. Said locations can be formed by the cavities, for example, and serve to influence the sliding friction between the end surface and the contact surface.

If the covering element is elastically deformable, particularly in the region of the protrusion or the recess, then it is possible to define the distance between the contact surface of the covering element and the end surface of the grip so that the covering element must be somewhat compressed when placing on the connecting element in order to displace the protrusion into the end segment. Due to the elastic deformation associated with the compression, a return force acting in the axial direction arises and is greatest at the minimum and reliably presses the covering element and the connecting element against each other in the end segment.

The covering element advantageously comprises a mounting element on the top side thereof that this suitable for holding a ball marker, particularly in the form of a chip. The ball marker is used to mark the position of a golf ball on the green in order to then be able to remove said ball. Coins or buttons on golf gloves intended for the purpose are commonly used as ball markers. Increasing popular and commonly used as promotional advertising gifts are chip-shaped ball markers that can be individually designed or imprinted.

The insertion element preferably comprises a retaining segment preferably flat in design, and prongs protruding from the retaining segment, preferably curved in design. The insertion element is thus a repair tool, a so-called pitchfork, the prongs thereof being inserted into the grass around the pitchmark and displaced in a manner suitable for erasing the deformation in the sod. The curvature of the prongs helps the prongs to be inserted gently into the grass, so that permanent damage to the sod is prevented.

In order to attach the insertion element to the connecting element, the connecting element comprises a first opening on the top side, in which the retaining segment is disposed. The connecting element preferably comprises a second opening on the shell surface thereof, in which a retaining screw fixing the retaining segment is received. In order to assemble the insertion element, the retaining segment is thereby inserted into the first opening and then the retaining screw, implemented as a set screw for example, is tightened in the second, threaded opening.

In a preferred embodiment of the device according to the invention, the attaching element and the connecting element are connected to each other by means of a screw connection. The connecting element preferably has a pass-through opening extending from the top side to the bottom side for receiving a screw preferably extending in the axial direction. The attaching element advantageously has a top side and a bottom side and has a contact surface implemented particularly on the bottom side for supporting a nut interacting with the screw.

In this context it is particularly advantageous if the connecting element comprises a clamping surface on the bottom side extending at a first angle to the axial direction, and the attaching element comprises a clamping surface on the top side having a center and extending at a second angle to the axial direction. The first angle and the second angle preferably form supplementary angles, that is, the sum thereof is 180°. The clamping surfaces in this case are parallel. The first angle is preferably between 130° and 170°, particularly between 140° and 160°, such as approximately 150°, and the second angle is preferably between 10° and 50°, particularly between 20° and 40°, such as approximately 30°.

The attaching element preferably comprises an elongated hole extending in the axial direction from the top side to the contact surface for the nut, said hole receiving the screw with radial clearance and being disposed outside of the center of the clamping surface. By tightening the screw, the connecting element and the attaching element are pressed against each other at the clamping surfaces. The eccentric arrangement of the elongated hole and the radial clearance cause the connecting element and the attaching element to slide apart from each other a short distance along the clamping surfaces when the screw is tightened, until the screw contacts the edge of the elongated hole in the radial direction. The offset between the connecting element and the attaching element resulting from the sliding apart in the radial direction makes it possible for the device according to the invention to the attached by means of a force fit in particular to the grip of a golf club.

In a further preferred embodiment of the device according to the invention, the attaching element and the connecting element are also connected to each other by means of a screw connection, but the attaching element comprises at least one clamping element made of a deformable material and at least one pressure element acting on the clamping element. The clamping element and the pressure element are preferably pressed against each other by means of the screw connection. When pressed, the clamping element is deformed. A bulging of the clamping element arising in this manner makes it possible to attach the device according to the invention in a force-fit manner, particularly to the grip of a golf club. The relatively severe bulging of the clamping element also makes it possible to compensate for manufacturing tolerances.

In a further preferred embodiment of the device according to the invention, the attaching element and the connecting element are implemented as one piece. The attaching element preferably comprises a circumferential surface suitable for being adhesively attached to an inner surface of the grip.

The golf club according to the invention, particularly implemented as a putter, comprises a shaft, a grip disposed at one end of the shaft, and a head disposed at the other end of the shaft. The golf club is characterized in that the device according to the invention is attached to the grip.

In a preferred embodiment of the golf club according to the invention, the grip comprises a particularly tubular cavity having an inner surface and in which the attaching element and/or the connecting element, particularly the bottom part of the connecting element, are disposed. The cavity can be formed by the shaft, for example.

The attaching element is preferably attached to the grip by means of a force fit. Said embodiment is available if the device according to the invention is retrofitted on conventional golf clubs. The circumferential surface of the attaching element or the clamping element preferably makes a force-fit contact with the inner surface of the grip. The offset of the connecting element and the attaching element or the bulging of the clamping element brings about an effective force fit ensuring that the device according to the invention remains securely and permanently connected to the grip of the golf club.

The attaching element can, however, be alternatively or additional connected to the grip by means of an adhesive. In this case the circumferential surface of the attaching element, on which the adhesive can be applied, preferably makes adhesive contact with the inner surface of the grip.

Details and further advantages of the invention are shown in the description of preferred embodiment examples below. The drawings show the embodiment examples only in schematic form, showing in detail:

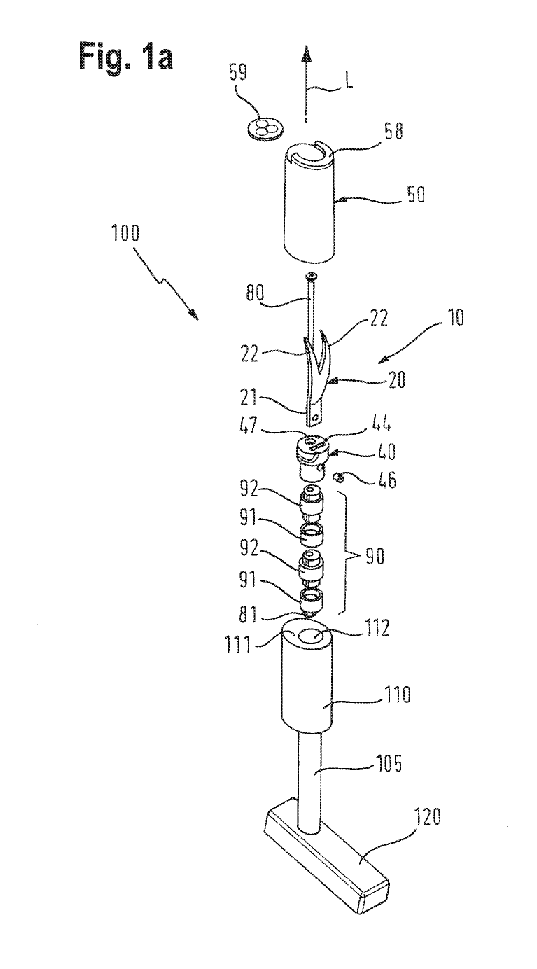

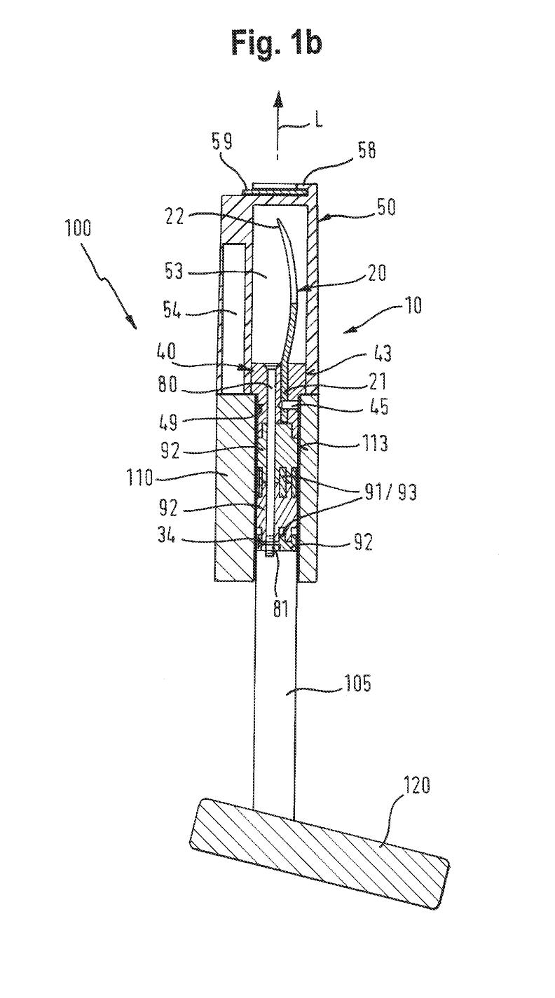

FIG. 1a an exploded view of a golf club showing a first embodiment of the device according to the invention;

FIG. 1b A longitudinal section through the first embodiment;

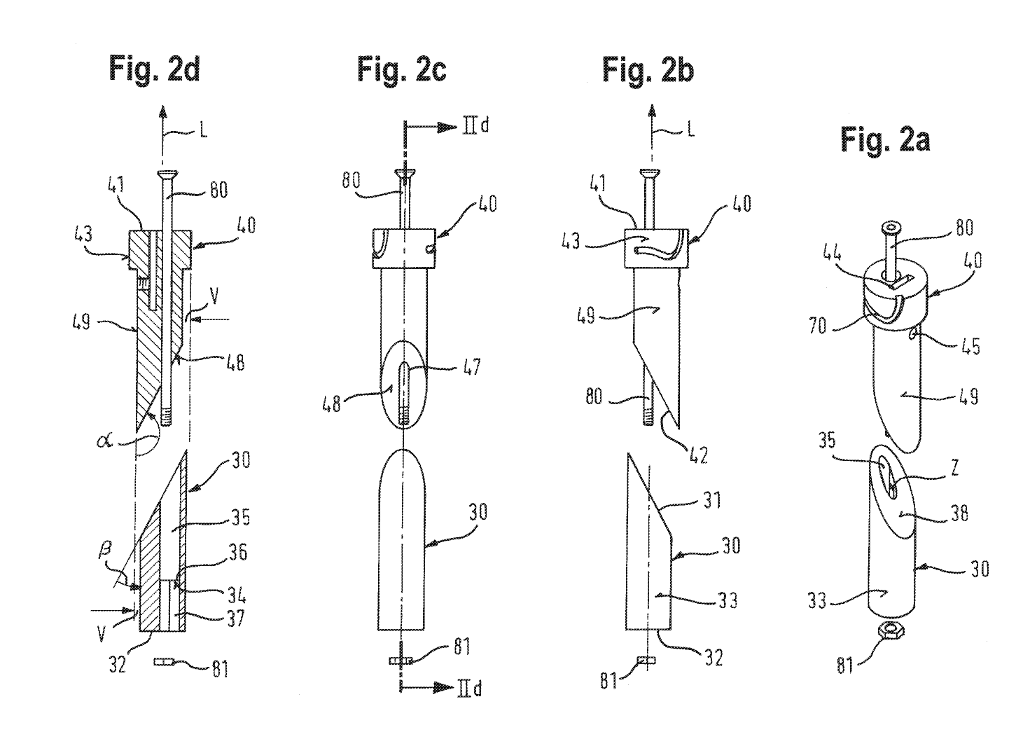

FIG. 2a A perspective view of the connecting element and the attaching element according to a second embodiment of the device according to the invention;

FIG. 2b A side view of the connecting element and attaching element according to the second embodiment;

FIG. 2c A further side view according to FIG. 2b;

FIG. 2d A section along the line lid-lid in FIG. 2c;

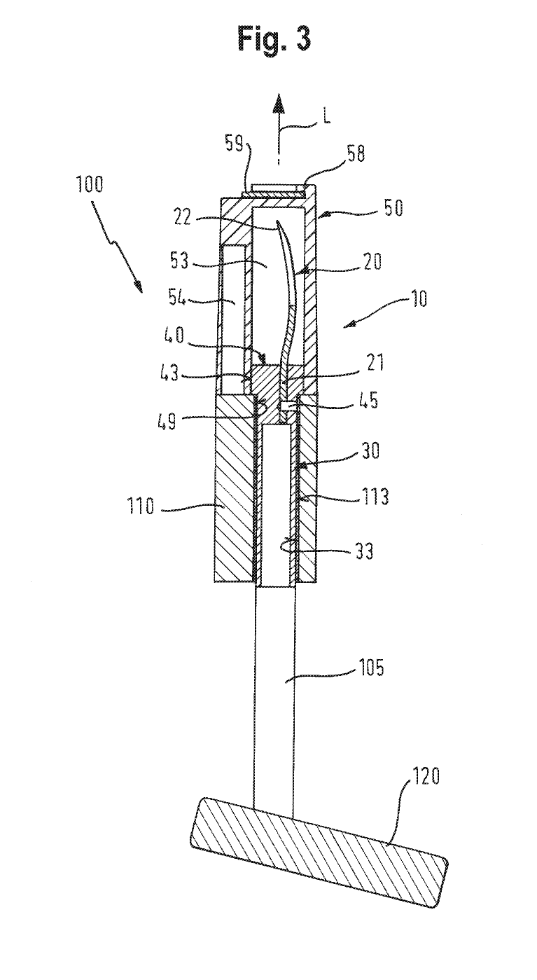

FIG. 3 A longitudinal section through a third embodiment of the device according to the invention;

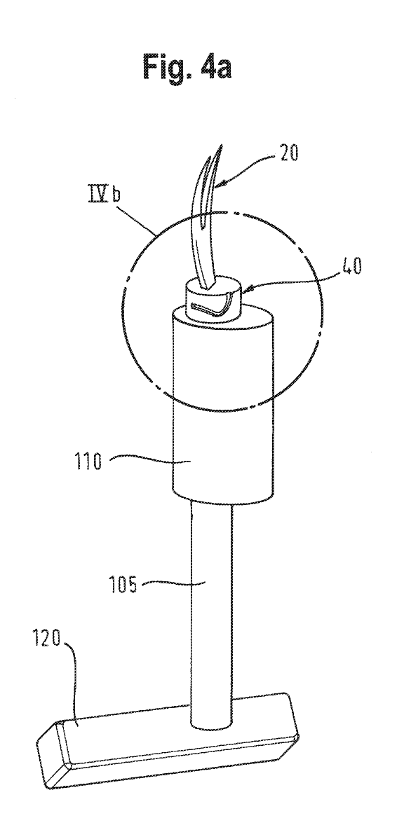

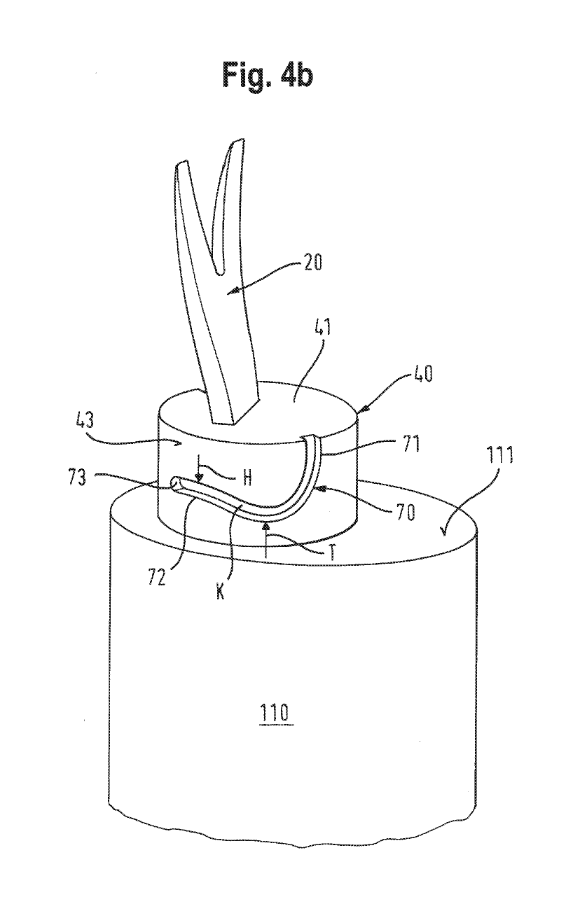

FIG. 4a A perspective view of the golf club according to the invention with the covering element removed;

FIG. 4b A magnified view of the area labeled as IVb in FIG. 4a;

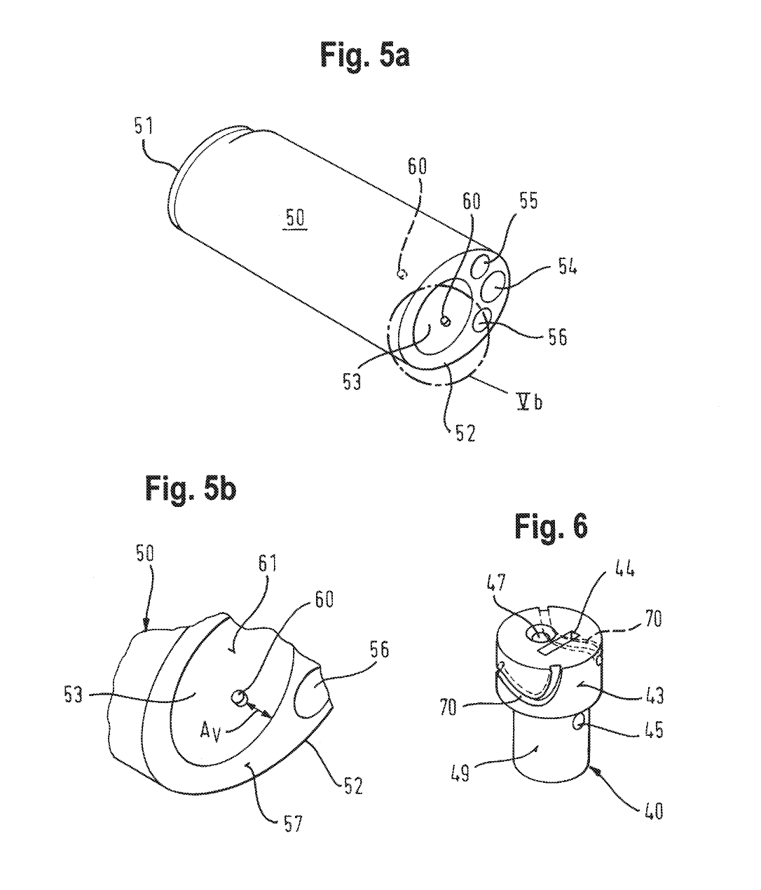

FIG. 5a A perspective view of a covering element;

FIG. 5b A magnified view of the area labeled as Vb in FIG. 5a;

FIG. 6 A perspective view of a connecting element;

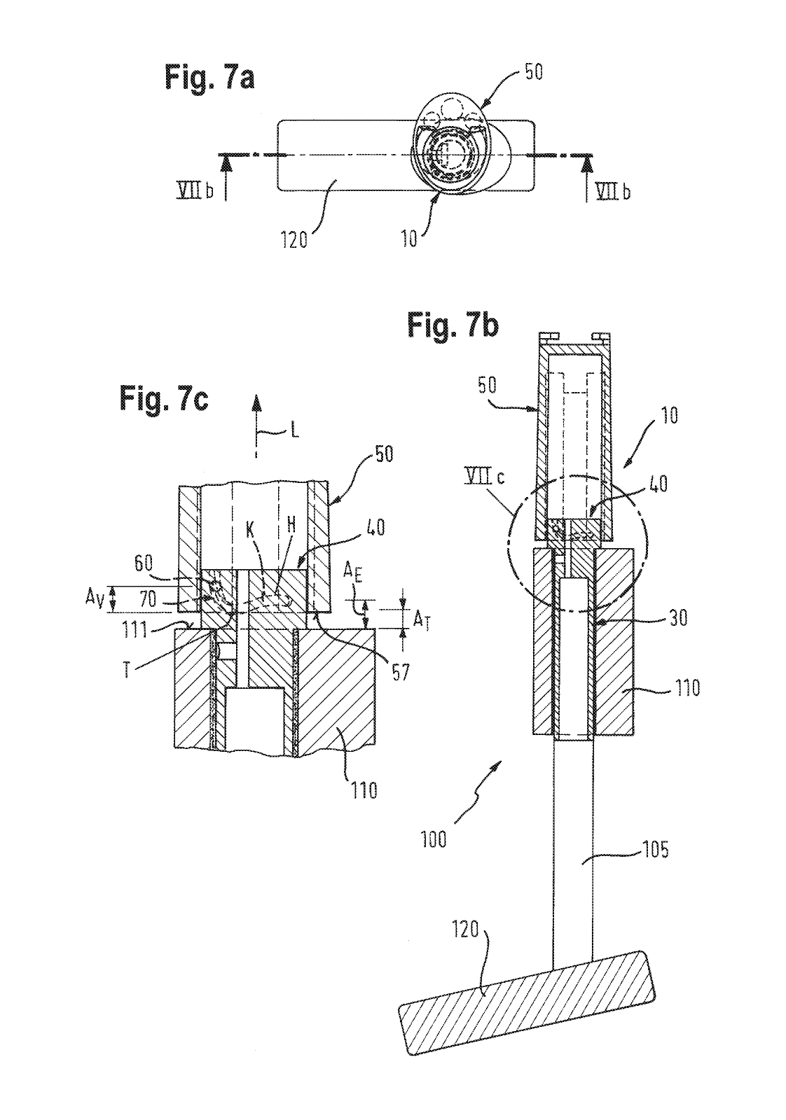

FIG. 7a A plan view of the golf club according to the invention, showing the covering element in an unlocked position;

FIG. 7b A section along the line VIIb-VIIb in FIG. 7a;

FIG. 7c A magnified view of the area labeled as VIIc in FIG. 7b;

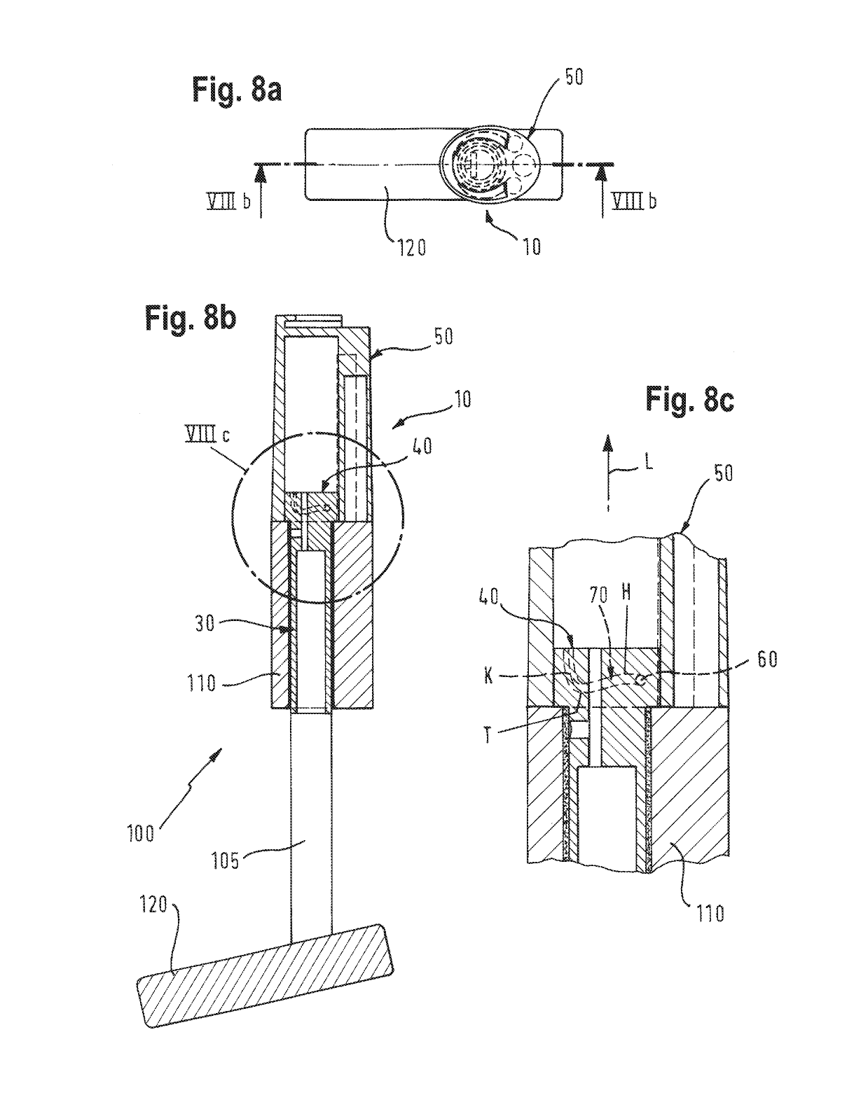

FIG. 8a A plan view of the golf club according to the invention, showing the covering element in a locked position;

FIG. 8b A section along the line VIIIb-VIIIb in FIG. 8a, and;

FIG. 8c A magnified view of the area labeled as VIIIc in FIG. 8b;

The golf club 100 shown in FIGS. 1a and 1b is particularly implemented as a putter and comprises a shaft 105, a grip 110 disposed at one end of the shaft 105, a head 120 disposed at the other end of the shaft 105, and a device 10 for repairing uneven areas in a green space disposed on a ground and attached to the grip 110.

The device 10 comprises an insertion element 20 implemented as a pitchfork, a covering element 50 covering the insertion element 20, a connecting element 40, and an attaching element 30, 90.

The insertion element 20 comprises a flat retaining segment 21 and prongs 22 protruding from the retaining segment 21. The prongs 22 are curved in design. The connecting element 40 has a top side 41 facing away from the attaching element 30, 90 and a bottom side 42 facing toward the attaching element 30, 90 and comprises a top part and a bottom part, as is particularly evident in FIG. 6 as well, each implemented as a circular cylinder. The bottom part facing the attaching element 30, 90 comprises a smaller diameter than the top part. The connecting element 40 comprises a first opening 44 on the top side 41 thereof, in which the retaining segment 21 is disposed. A second opening 45 is disposed in the area of the bottom part of the connecting element 40 and extend from a shell surface 49 to the first opening 44. The second opening 45 has an internal thread into which a retaining screw 46 implemented as a set screw is threaded in order to fix the retaining segment 21 in the first opening 44.

The attaching element 90 and the connecting element 40 are connected to each other in a first embodiment of the device 10 by a screw connection comprising a screw 80 and a nut 81. The connecting element 40 has a pass-through opening 47 extending from the top side 41 to the bottom side 42 for receiving the screw 80 extending in an axial direction L.

The attaching element 90 is made of a plurality of clamping elements 91 and pressure elements 92 in the first embodiment of the device 10 shown in FIGS. 1a and 1b, said elements being disposed alternately one after the other in the axial direction L. The clamping elements 91 and the pressure elements 92 are pressed against each other by the screw connection 80, 81. To this end, a contact surface 34 for the nut 81 is present on the lowest pressure element 92 in the axial direction L. The clamping elements 91 are made of a deformable material such as rubber or plastic and are acted on by the pressure elements 91 in the axial direction L and thereby compressed. The compression causes a bulging 93 penetrating the slits formed between the pressure elements 92 and in this manner causes a force fit against the inner surface 113 of a cavity 112 of the grip 110, holding the device 10 reliably against the grip 110. The tubular cavity 112 is formed, as is particularly evident in FIG. 1b, by the walls of the shaft 105 in the region of the grip 110, so that a secure force-fit connection results from the strength of the walls.

The covering element 50 has a top side 51 facing away from the grip 110 and a bottom side 52 facing toward the grip 110. A cavity 52 opening at the bottom side 52 receives the insertion element 20 and the top part of the connecting element 40. The bottom part of the connecting element 40, in contrast, makes contact in the cavity 112. Cavities 54, 55, 56 extend in the axial direction L parallel to the cavity 53, as can be seen particularly in FIG. 5a as well. The covering element 50 comprises a contact surface 57 on the bottom side 52 thereof making contact with an end surface 111 of the grip 110 when the covering element 50 is connected to the connecting element 40. The cavities 54, 55, 56 influence the deformability of the covering element 50, open at the contact surface 57, and thereby also influence the sliding friction between the contact surface 57 and the end surface 111. The cavities 54, 55, 56 thereby form a friction-reducing surface in the region of the contact surface 57. The covering element 50 has a mounting element 58 on the top side 51 thereof for retaining a chip-shaped ball marker 59.

As can be seen in FIGS. 2a through 2d, the second embodiment of the device 10 comprises an attaching element 30 having a top side 31 facing toward the connecting element 40 and a bottom side 32 facing away from the connecting element 40. The attaching element 30 is implemented as a circular cylinder and comprises a circumferential surface 33. The connecting element 40 forms a clamping surface 48 on the bottom side 42 thereof extending at a first angle α to the axial direction L. The attaching element 30 forms a clamping surface 38 on the top side 31 thereof having a center Z and extending at a second angle β to the axial direction L. The first angle α and the second angle β preferably form supplementary angles, that is, the sum thereof is 180°. In the present case, the first angle α is approximately 150° and the second angle β is approximately 30°. The clamping surfaces 48, 38 are therefore parallel. Depending on the application, however, the clamping surfaces 38, 48 can also enclose an angle. An elongated hole 35 extends through the attaching element 30 from the top side 31 to the contact surface 34 supporting the nut 81 and receives the screw 80 with a clearance in the radial direction, that is, in a direction perpendicular to the axial direction L, and is disposed outside of the center Z of the clamping surface 38. The contact surface 34 is formed by an offset 36 in a recess 37 on the bottom side 32. The recess 37 receives the nut 81 and prevents rotation thereof.

By tightening the screw 80, the connecting element 40 and the fastening element 30 are pressed against each other at the clamping surfaces 38, 48. The eccentric arrangement of the elongated hole 35 and the radial clearance of the screw 80 cause the connecting element 40 and the attaching element 30 to slide apart from each other a short distance along the clamping surfaces 38, 48 when the screw 80 is tightened, said distance being such that the screw 80 makes contact with the edge of the elongated hole 35 in the radial direction. In this manner, an offset V arises between the connecting element 40 and the attaching element 30, as can be particularly seen in FIG. 2d. The bottom part of the connecting element 40 and the attaching element 30 are disposed in the cavity 112 for attaching the device 10 to the golf club 100. When the screw 80 is tightened, then the resulting offset V causes the shell surface 49 of the connecting element 40 and the circumferential surface 33 of the attaching element 30 to be pressed against the inner surface 113, whereby a force fit arises between the attaching element 30 and the connecting element 40 on one hand and the grip 110 on the other.

As can be seen in FIG. 3, the attaching element 30 and the connecting element 40 are implemented as a single part in the third embodiment of the device 10. The circumferential surface 33 of the attaching element 30 and the shell surface 49 in the region of the bottom part of the connecting element 30 form an attaching surface contacting the inner surface 113 and—coated with an adhesive, for example—bring about an adhesive connection between the attaching element 30 and the connecting element 40 on one hand and the grip 110 on the other.

The different embodiments of the device 10 differ in the Implementation of the attaching element 30 and the type of attachment of the device 10 to the golf club 100. The embodiments have in common, however, the implementation of the covering element 50 and the releasable connection of the covering element 50 to the connecting element 40 by means of a bayonet joint. As can be seen particularly in FIGS. 4a and 4b and FIG. 6, the connecting element 40 has two recesses 70 for forming the bayonet joint and implemented as a groove in regions of the shell surface 43 facing away from each other. The covering element 50 comprises two protrusions or cams 60 implemented on an inner surface 61 of the cavity 53 and engaging in the recesses 70 when the covering element 50 is place on the connecting element 40. As can be seen in FIGS. 5a and 5b, the protrusions 60 are spaced apart from the contact surface 57 at a distance AV.

The recesses 70 each follow a trajectory K extend from a starting segment 71 opening at the top side 41 to an end segment 72 ending at an end stop 73, as can be seen particularly in FIG. 4b. In the transition region from the starting segment 71 to the end segment 72, the trajectory K has a local minimum T located at a distance AT from the end surface 111 and the sign of the slope of the trajectory K changes in the region thereof. The trajectory K is falling in the region of the starting segment 71 and rises after reaching the minimum T in the region of the end segment 72. The slope of the trajectory K decreases in the end segment 72. Before a local maximum H is reached shortly before the end stop 73, the trajectory K runs substantially parallel to the end surface 111. The recess 70 thus are similar to a sideways L.

The covering element 50 completes the grip 110 and therefore is made of a material that fulfills the requirements of a golfer in terms of haptics and hardness of a grip, such as rubber. Rubber, as is known, is an elastically deformable material. The covering element 50 can therefore be compressed a short distance when placed on the end surface 111, whereby a return force in the axial direction L is generated. Said force is utilized when the covering element 50 is connected to the connecting element 40 by means of a push and turn motion, as can be seen clearly in FIGS. 7a through 8c.

In FIGS. 7a, 7b, and 7c, the covering element 50 is shown after being place on the connecting element 40. The covering element 50 is rotated in said unlocked position by about 90° relative to the locked position shown in FIGS. 8a, 8b, and 8c, wherein the protrusion 60 makes contact with the end stop 73 as can be particularly seen in FIG. 7a. The protrusion 60 has penetrated a short distance into the recess 70 running nearly vertically at the beginning of the starting segment 71, as seen particularly in FIG. 7c. In order to displace the protrusion 60 from the starting segment 71 into the end segment 72, it is necessary to rotate the covering element 50, whereby the protrusion 60 is guided along the trajectory K. Because the trajectory K is falling in the region of the starting segment 71, the covering element 50 approaches the end surface 111 of the grip 110 due to the rotary displacement. Before the protrusion 60 reaches the minimum T, the contact surface 57 makes contact with the end surface 111. A displacement of the protrusion 60 past the minimum T thus requires that the covering element 50 be compressed.

The magnitude of the compression results from the difference between the distance AT and the distance between the point on the trajectory K currently being traversed and the end surface 111. The compression is therefore greatest in the region of the minimum T, located at a minimum distance AT from the end face 11 and decreases again toward the end stop 73, located at a distance AE from the end face 11. The return force arising from the compression of the covering element 50 in the axial direction L presses the protrusion 60 against the lower edge of the recess 70 in the axial direction L. The maximum H, located just before the end stop 73 and after reaching which the trajectory K falls again slightly toward the end stop 73, thus ensures that the protrusion 60 is held against the end stop 73 by means of a form and force fit, as can be seen particularly in FIG. 8c. The covering element 50 and the connecting element 40 are thus reliably locked when the protrusion 60 makes contact with the end stop 73.

The previously described device 10 adds to the golf club 100 a repair tool that is reliably stowed by means of the covering element 50 when not in use. The bayonet joint resulting from the engagement of the protrusion 60 in the recess 70 and the implementation of the recess 70 as a trajectory K extending along the shell surface 43 allows the covering element 50 to be releasably connected to the connecting element 40 by means of a push and turn motion that is easy to execute, and to release the same again easily by means of the reverse rotational displacement. At the same time, the bayonet joint ensures that the protrusion 60 is retained in the recess 70 by means of a form and force fit in the locked position of the covering element 50, preventing unintentional release of the covering element 50 and thus not interfering with the handling of the golf club 100.

Reference list

| | |
|---|---|
| 10 | Device |
| 20 | Insertion element |
| 21 | Retaining segment |
| 22 | Prongs |
| 30 | Attaching element |
| 31 | Top side |
| 32 | Bottom side |
| 33 | Circumferential surface |
| 34 | Contact area |
| 35 | Elongated hole |
| 36 | Offset |
| 37 | Recess |
| 38 | Clamping surface |
| 40 | Connecting element |
| 41 | Top side |
| 42 | Bottom side |
| 43 | Shell surface |
| 44 | First opening |
| 45 | Second opening |
| 46 | Retaining screw |
| 47 | Pass-through opening |
| 48 | Clamping surface |
| 49 | Shell surface |
| 50 | Covering element |
| 51 | Top side |
| 52 | Bottom side |
| 53 | Cavity |
| 54 | Cavity |
| 55 | Cavity |
| 56 | Cavity |
| 57 | Contact surface |
| 58 | Mounting element |
| 59 | Ball marker |
| 60 | Protrusion |
| 61 | Inner surface |
| 70 | Recess |
| 71 | Starting segment |
| 72 | End segment |
| 73 | End stop |
| 80 | Screw |
| 81 | Nut |
| 90 | Attaching element |
| 91 | Clamping element |
| 92 | Pressure element |
| 93 | Bulge |
| 100 | Golf club |
| 105 | Shaft |
| 110 | Grip |
| 111 | End surface |
| 112 | Cavity |
| 113 | Inner surface |
| 120 | Head |
| AV | Distance |
| AE | Distance |
| AT | Distance |
| H | Maximum |
| K | Trajectory |
| L | Axial direction |
| T | Minimum |
| V | Offset |
| Z | Center |
| α | Angle |
| β | Angle |

1. A device for repairing uneven areas in a green space disposed on a ground, the device being suitable for being attached to a grip of a golf club, comprising:
an attaching element by means of which the device can be attached to the grip;
an insertion element suitable for being inserted into the ground for repairing the uneven areas;
a covering element for covering the insertion element; and
a connecting element that comprises a shell surface and can be releasably connected to the covering element by means of a bayonet joint;
wherein the connecting element comprises at least one recess having a starting segment and an end segment for forming the bayonet joint, and the covering element comprises at least one protrusion engaging in the recess and being displaceable from the starting segment to the end segment;
wherein the recess is implemented as a groove extending along the shell surface and following a trajectory (K); and
wherein the trajectory (K) has a minimum (T) in the transition region from the starting segment to the end segment.

2. A device for repairing uneven areas in a green space disposed on a ground, the device being suitable for being attached to a grip of a golf club, comprising:
an attaching element by means of which the device can be attached to the grip;
an insertion element suitable for being inserted into the ground for repairing the uneven areas;
a covering element for covering the insertion element; and
a connecting element that comprises a shell surface and can be releasably connected to the covering element by means of a bayonet joint;
wherein the covering element comprises at least one recess having a starting segment and an end segment for forming the bayonet joint, and the connecting element comprises at least one protrusion engaging in the recess and being displaceable from the starting segment to the end segment;
wherein the recess is implemented as a groove extending along the shell surface and following a trajectory (K); and
wherein the trajectory (K) has a minimum (T) in the transition region from the starting segment to the end segment.

3. The device of claim 1, wherein the shell surface is cylindrical, wherein the connecting element comprises a top part and a bottom part having a smaller diameter than the top part.

4. The device of claim 1, wherein the sign of a slope of the trajectory (K) in the starting segment is opposite the sign of a slope in the end segment at least in the region of the minimum (T), wherein the protrusion is displaceable against the action of a return force acting in an axial direction (L) from the starting segment to the end segment, and wherein an end stop for the protrusion bounds the end segment, wherein the slope of the trajectory (K) further decreases in the end segment toward the end stop.

5. (canceled)

6. The device of claim 1, wherein the covering element comprises a top side and a bottom side and at least one cavity opening on the bottom side, wherein the cavity is suitable for receiving the insertion element and the connecting element, wherein the covering element is manufactured of an elastically deformable material at least in regions including at least one of the protrusion and the recess, and wherein the covering element comprises a contact surface on the bottom side thereof, suitable for making contact with an end surface of the grip of a golf club, wherein the contact surface comprises locations having a surface for reducing friction at least in segments.

7. (canceled)

8. (canceled)

9. The device of claim 6, wherein the covering element comprises a mounting element on the top side thereof, suitable for retaining a ball marker in the form of a chip.

10. The device of claim 1, wherein the insertion element comprises a retaining segment, flat in design, and prongs, protruding away from the retaining segment and curved in design, wherein the connecting element comprises a first opening on the top side thereof in which the retaining segment is disposed, wherein the connecting element comprises a second opening on the shell surface thereof, in which a retaining screw fixing the retaining segment is received.

11. (canceled)

12. The device of claim 3, wherein the attaching element and the connecting element are connected by the means of a screw connection, wherein the connecting element has a pass-through opening extending from the top side to the bottom side in order to receive a screw, which is extending in the axial direction (L) and wherein the attaching element comprises a top side and a bottom side and has a contact surface implemented on the bottom side for supporting a nut interacting with the screw.

13. The device of claim 12, wherein the connecting element comprises a clamping surface on the bottom side thereof extending at a first angle (α) to the axial direction (L), and that the attaching element comprises a clamping surface on the top side thereof comprising a center (Z) and extending at a second angle (β) to the axial direction (L), wherein the first angle (α) and the second angle (β) form supplementary angles, and wherein the first angle (α) is between 130° and 170°, and the second angle (β) is between 10° and 50°, and wherein the attaching element comprises an elongated hole extending from the top side to the contact surface in the axial direction (L) for receiving the screw with radial clearance and being disposed outside of the center (Z) of the clamping surface.

14. (canceled)

15. The device of claim 12, wherein the attaching element comprises at least one clamping element made of a deformable material and comprising at least one pressure element acting on the clamping element, wherein the clamping element and the pressure element are pressed against each other by means of the screw connection.

16. The device of claim 1, wherein the attaching element and the connecting element are implemented as a single piece, wherein the attaching element comprises a circumferential surface suitable for being attached to an inner surface of the grip by means of an adhesive.

17. A golf club, particularly a putter, comprising:
a shaft,
a grip disposed at one end of the shaft,
a head disposed at the other end of the shaft, and
a device attached to the grip including:
an attaching element by means of which the device can be attached to the grip;
an insertion element suitable for being inserted into the around for repairing the uneven areas;
a covering element for covering the insertion element; and
a connecting element that comprises a shell surface and can be releasably connected to the covering element by means of a bayonet joint;
wherein the connecting element comprises at least one recess having a starting segment and an end segment for forming the bayonet joint, and the covering element comprises at least one protrusion engaging in the recess and being displaceable from the starting segment to the end segment;
wherein the recess is implemented as a groove extending along the shell surface and following a trajectory (K); and
wherein the trajectory (K) has a minimum (T) in the transition region from the starting segment to the end segment.

18. The golf club of claim 17, wherein the grip comprises a cavity having an inner surface and in which at least one of the attaching element and the connecting element are disposed.

19. The golf club of claim 18, wherein attaching element is connected to the grip by means of a force fit, wherein at least one of the circumferential surface of the attaching element and the clamping element makes contact with the inner surface of the grip in a force-fit manner.

20. The golf club of claim 18, wherein attaching element is connected to the grip by means of an adhesive, wherein the circumferential surface of the attaching element makes contact with the inner surface of the grip in an adhesive manner.

21. The device of claim 2, wherein the shell surface is cylindrical, wherein the connecting element comprises a top part and a bottom part having a smaller diameter than the top part.

22. The device of claim 2, wherein the sign of a slope of the trajectory (K) in the starting segment is opposite the sign of a slope in the end segment at least in the region of the minimum (T), wherein the protrusion is displaceable against the action of a return force acting in an axial direction (L) from the starting segment to the end segment, and wherein an end stop for the protrusion bounds the end segment, wherein the slope of the trajectory (K) further decreases in the end segment toward the end stop.

23. The device of claim 2, wherein the covering element comprises a top side and a bottom side and at least one cavity opening on the bottom side, wherein the cavity is suitable for receiving the insertion element and the connecting element, wherein the covering element is manufactured of an elastically deformable material at least in regions including at least one of the protrusion and the recess, and wherein the covering element comprises a contact surface on the bottom side thereof, suitable for making contact with an end surface of the grip of a golf club, wherein the contact surface comprises locations having a surface for reducing friction at least in segments.

24. The device of claim 2, wherein the insertion element comprises a retaining segment, flat in design, and prongs, protruding away from the retaining segment and curved in design, wherein the connecting element comprises a first opening on the top side thereof in which the retaining segment is disposed, wherein the connecting element comprises a second opening on the shell surface thereof, in which a retaining screw fixing the retaining segment is received.

25. A golf club, particularly a putter, comprising:
a shaft,
a grip disposed at one end of the shaft,
a head disposed at the other end of the shaft, and
a device attached to the grip including:
an attaching element by means of which the device can be attached to the grip;
an insertion element suitable for being inserted into the ground for repairing the uneven areas;
a covering element for covering the insertion element; and
a connecting element that comprises a shell surface and can be releasably connected to the covering element by means of a bayonet joint;
wherein the covering element comprises at least one recess having a starting segment and an end segment for forming the bayonet joint, and the connecting element comprises at least one protrusion engaging in the recess and being displaceable from the starting segment to the end segment;
wherein the recess is implemented as a groove extending along the shell surface and following a trajectory (K); and
wherein the trajectory (K) has a minimum (T) in the transition region from the starting segment to the end segment.

26. The golf club of claim 25, wherein the grip comprises a cavity having an inner surface and in which at least one of the attaching element and the connecting element are disposed.
